(19) United States
(12) Patent Application Publication
(10) Pub. No.: US 2010/0053252 A1
(43) Pub. Date: Mar. 4, 2010

(54) LIQUID DISCHARGING APPARATUS AND METHOD OF CONTROLLING LIQUID DISCHARGING APPARATUS

(75) Inventor: Junichiro Matsushita, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/553,814

(22) Filed: Sep. 3, 2009

(30) Foreign Application Priority Data
Sep. 4, 2008 (JP) 2008-226800

(51) Int. Cl. B41J 29/38

(52) U.S. Cl. 347/17

(57) ABSTRACT

A liquid discharging apparatus includes a liquid discharging head having a nozzle opening, a pressure generating chamber communicating with the nozzle opening and a pressure generator that generates a change in the pressure of a liquid inside the pressure generating chamber, the liquid discharging head being capable of discharging the liquid from the nozzle opening by operation of the pressure generator; and a driving signal generator that is capable of repeatedly generating in constant periods a first driving signal and a second driving signal that each include a discharge pulse for discharging the liquid by driving the pressure generator; wherein, when the Helmholtz natural oscillation period inside the pressure generating chamber is denoted by Tc and n is taken to be a natural number, a time Δt from a beginning of a first discharge pulse included in the first driving signal to a beginning of a second discharge pulse included in the second driving signal satisfies (n−½)Tc<Δt<nTc.

### BACKGROUND

1. Technical Field

The present invention relates to a liquid discharging apparatus such as an ink jet printer or the like, and to a method of controlling the liquid discharging apparatus. More particularly, the invention relates to a liquid discharging apparatus that is capable of controlling discharge of a liquid by using a plurality of driving signals, and to a method of controlling the liquid discharging apparatus.

2. Related Art

For example, liquid discharging apparatuses are provided with a liquid discharging head that is capable of discharging a liquid. Liquid discharging apparatuses discharge a variety of liquids from such a liquid discharging head. Representative examples of such a liquid discharging apparatus include, for example, image recording apparatuses such as an ink jet printer (hereafter simply referred to as “printer”) that has an ink jet recording head (hereafter simply referred to as “recording head”) serving as a liquid discharging head and that performs recording of an image or the like by causing liquid ink to be discharged from nozzle openings of the recording head and hit a recording medium (discharge target) such as recording paper or the like. Furthermore, in recent years, liquid discharging apparatuses have not only been applied to image recording apparatuses, but have also been applied to various manufacturing apparatuses such as apparatuses for manufacturing color filters of liquid crystal displays and the like.

A recording head, which is one type of liquid discharging head, is provided with a series of ink flow paths that extend from a common ink chamber (common liquid chamber) to nozzles through pressure generating chambers, and is configured such that a change in the pressure of a liquid within a pressure generating chamber is generated by operation of a pressure generator such as a piezoelectric vibrator or the like, and this change in pressure is used to make it possible to discharge ink within the pressure generating chamber from a nozzle as ink. Moreover, this recording head is provided with an actuator unit (vibrator unit), which has a group of piezoelectric vibrators, a resin head case that houses this actuator unit, and flow path units that form the ink flow paths.

Furthermore, in recent years, printers have been proposed that adopt a configuration in which discharge pulses that cause different amounts (weight or volume) of ink to be discharged are assigned to a plurality of driving signals and ink is discharged by selectively supplying the discharge pulses included in the respective driving signals to piezoelectric vibrators (see, for example, JP-A-10-291310 and JP-A-2003-237113).

In this type of configuration, for example, there is a case where ink of respectively different amounts is discharged from adjacent nozzle openings in a certain recording period (period in which a driving signal is repeatedly generated). For example, ink is discharged from one nozzle opening, from among the adjacent nozzle openings, by using a dot discharge pulse for forming a certain type of dot from among a plurality of types of dots of different sizes, and ink is discharged from another nozzle opening by using a dot discharge pulse for forming another type of dot from among the plurality of types of dots of different sizes. However, there is a concern that, when discharge from the other nozzle opening is performed, the discharge operation will exert an influence on the one nozzle opening. That is, in recent years, together with the reduction in the weight of and space occupied by recording heads, nozzle openings have also been formed with high density, adjacent nozzle openings are close to one another, and the thickness of partitions that divide adjacent pressure generating chambers from one another has also become small. Consequently, pressure oscillations generated in the ink inside a pressure generating chamber by driving of a piezoelectric vibrator become easily transmitted to an adjacent pressure generating chamber via the partition. Due to this, there is a concern that, when discharging is performed from one nozzle opening, vibration of a meniscus (surface of ink exposed through the nozzle opening) interferes with another nozzle opening (so-called “crosstalk”). Furthermore, depending on the phase of this vibration, discharge from the other nozzle opening sometimes becomes unstable. In particular, when a discharge operation is started in a state where a meniscus is bulging toward a discharge side (the side opposite to a pressure generating chamber side), an air bubble is drawn completely in together with drawing in of the meniscus, and, due to this air bubble, a phenomenon is observed in which discharging of ink becomes unstable in that, for example, the flight direction of satellite ink (an ink droplet attached to the rear of main ink) is curved.

### SUMMARY

An advantage of some aspects of the invention is that it provides a liquid discharging apparatus that is capable of suppressing crosstalk when a liquid is discharged from adjacent nozzle openings within the same discharge period, and a method of controlling the liquid discharging apparatus.

A liquid discharging apparatus according to an aspect of the invention includes a liquid discharging head having a nozzle opening, a pressure generating chamber communicating with the nozzle opening and a pressure generator that generates a change in the pressure of a liquid in the pressure generating chamber, the liquid discharging head being capable of discharging the liquid from the nozzle opening by operation of the pressure generator; and a driving signal generator that is capable of repeatedly generating in constant periods a first driving signal and a second driving signal that each include a discharge pulse for discharging the liquid by driving the pressure generator. Here, when the Helmholtz natural oscillation period within the pressure generating chamber is denoted by Tc and n is taken to be a natural number, a time Δt from a beginning of a first discharge pulse included in the first driving signal to a beginning of a second discharge pulse included in the second driving signal satisfies (n−½)Tc<Δt<nTc.

In the above-described liquid discharging apparatus, in a state in which a meniscus exposed though the nozzle opening has been drawn inward in a direction toward the pressure generating chamber by pressure oscillations of the Helmholtz natural oscillation period Tc generated by driving of the pressure generator by using the first discharge pulse, it is preferable that the time Δt be set so that a discharge operation is started by using the second discharge pulse. The term “discharge operation” refers to the following series of operations. A discharge pulse is applied to a pressure generator to drive the pressure generator, whereby a liquid is discharged from a nozzle opening by a change in volume (expansion or contraction) of the pressure generating chamber.

According to this liquid discharging apparatus, in the case where discharging of a liquid is respectively performed from one nozzle opening from among adjacent nozzle openings by using a first discharge pulse and from another nozzle opening from among the adjacent nozzle openings by using a second discharge pulse, by setting a time Δt from a beginning of the first discharge pulse included in the first driving signal to a beginning of the second discharge pulse included in the second driving signal is set to (n−½)Tc<Δt<nTc, discharge from the other nozzle opening is performed at a time at which the meniscus has been drawn in toward the pressure generating chamber side by pressure oscillations of the Helmholtz natural oscillation period Tc generated by the discharge operation in the one nozzle opening. Accordingly, it becomes difficult for an air bubble to be drawn in during a discharge operation of the other nozzle opening and thereby discharge from the other nozzle opening can be stabilized.

Furthermore, an embodiment of the invention is preferably configured such that the first discharge pulse and the second discharge pulse cause different amounts of liquid to be discharged. Moreover, in the above-described configuration, it is preferable that the second discharge pulse causes a minimum amount of liquid to be discharged and the first discharge pulse causes a maximum amount of liquid to be discharged.

### BRIEF DESCRIPTION OF THE DRAWINGS

An embodiment of the invention will be described with reference to the accompanying drawings, wherein like numbers reference like elements.

FIG. 1 is an explanatory block diagram of an electrical configuration of an ink jet printer.

FIG. 2 is an explanatory waveform diagram of the structure of driving signals.

FIG. 3 is a sectional view of essential parts of a recording head.

FIG. 4 is a graph illustrating the change in the flight speed of ink when the time from the beginning of a first discharge pulse to the beginning of a second discharge pulse is changed.

FIG. 5 is an explanatory view of the structure of driving signals in another embodiment.

### DESCRIPTION OF EXEMPLARY EMBODIMENTS

Hereafter, an embodiment according to the invention will be described with reference to the accompanying drawings. The embodiment described below as a preferred concrete example of the invention has various restrictions therein. However, the scope of the invention is not limited by this embodiment, unless otherwise noted. Furthermore, hereafter, an ink jet recording apparatus will be described as an example of a liquid discharging apparatus of the invention.

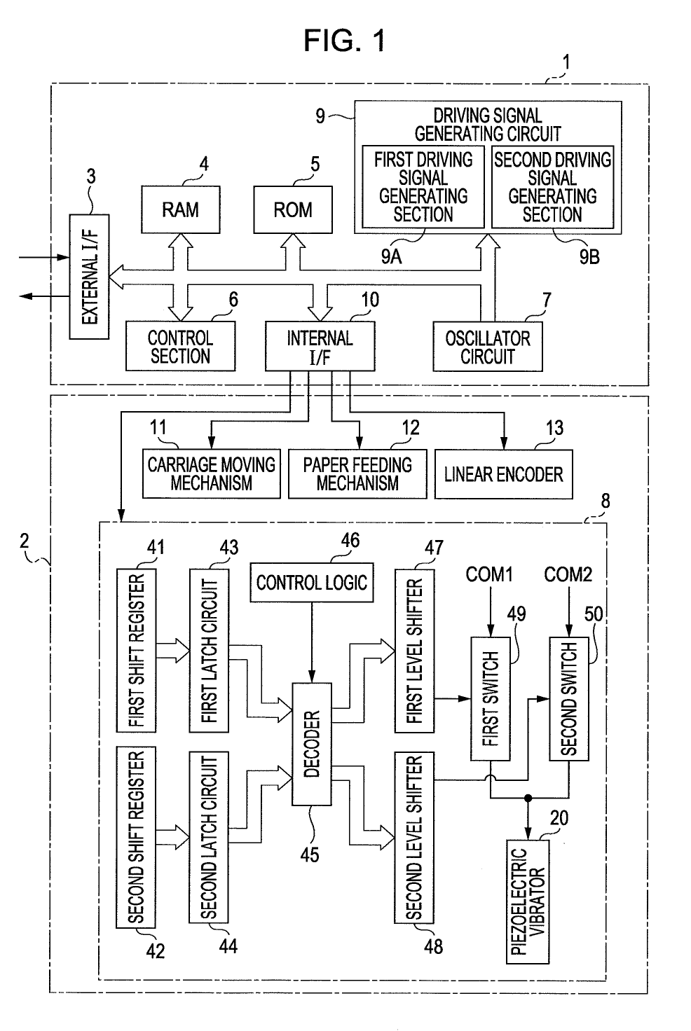

FIG. 1 is an explanatory block diagram of an electrical configuration of a printer. The printer, illustrated as an example, includes a printer controller 1 and a print engine 2. The printer controller 1 is provided with an external interface (external I/F) 3 that sends and receives data to and from an external apparatus such as a host computer, which is not shown, or the like; a RAM 4 that stores a variety of data and the like; a ROM 5 in which a control program, and the like, for a variety of data processing is stored; a control section 6 constituted by a CPU or the like; an oscillator circuit 7 that generates a clock signal; a driving signal generating circuit 9 that generates driving signals (COM1, COM2) to be supplied to a recording head 8; and an internal interface 10 (internal I/F 10) for sending recording data, driving signals and the like to the print engine 2.

The external I/F 3 receives print data such as image data or the like from a host computer or the like. Furthermore, state signals such as a busy signal, an acknowledgement signal and the like are output from the external I/F 3 to an external apparatus. The RAM 4 is used as a reception buffer, an intermediate buffer, an output buffer, a work memory and the like. In addition, the ROM 5 stores a variety of control programs to be executed by the control section 6, font data and a graphic function, a variety of procedures, and the like.

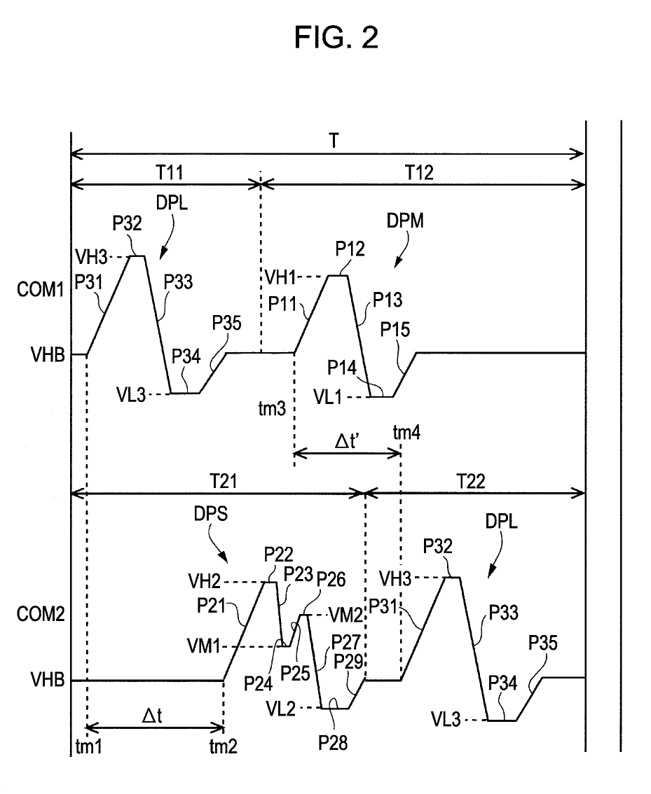

The driving signal generating circuit 9 is provided with a first driving signal generating section 9A that is capable of generating a first driving signal COM1 and a second driving signal generating section 9B that is capable of generating a second driving signal COM2. In addition, as shown in FIG. 2, the first driving signal COM1 is a series of signals including, within a recording period (discharge period) T, a large dot discharge pulse DPL (corresponding to a first discharge pulse in the embodiment of the invention) and a middle dot discharge pulse DPM. The first driving signal COM1 is repeatedly generated every recording period T. In the present embodiment, one recording period T of the first driving signal COM1 is divided into two periods (pulse generation periods) T11 and T12. Furthermore, the large dot discharge pulse DPL is generated in the period T11, and the middle dot discharge pulse is generated in the period T12.

On the other hand, the second driving signal COM2 is a series of signals including, within the recording period T, a small dot discharge pulse DPS (corresponding to a second discharge pulse in the embodiment of the invention) and the large dot discharge pulse DPL. One recording period T of the second driving signal COM2 is divided into two pulse generation periods T21 and T22, and the small dot discharge pulse DPS is generated in the period T21 and the large dot discharge pulse DPL is generated in the period T22. Next, these driving signals COM1 and COM2 will be described in detail.

The control section 6 controls each section of the printer in accordance with a control program and the like stored in the ROM 5 and converts print data from the external apparatus into recording data to be sent to the recording head 8. Furthermore, in the conversion time for the recording head, the control section 6 first reads out print data stored in the RAM 4, converts the print data into intermediate code data and stores the intermediate code data in the intermediate buffer provided in the RAM 4. Next, the control section 6 analyses the intermediate code data read out from the intermediate buffer and converts the intermediate code data into recording data (dot pattern data) for every dot by referring to the font data, the graphic function and the like within the ROM 5. Furthermore, the control section 6 supplies a latch signal, a channel signal and the like to the recording head 8 via the internal I/F 10. A latch pulse and a channel pulse respectively included in the latch signal and the channel signal regulate the supply timing of each of the pulses constituting the driving signals COM1 and COM2.

Next, the print engine 2 will be described. As shown in FIG. 1, the print engine 2 is provided with the recording head 8, a carriage moving mechanism 11, a paper feeding mechanism 12, a linear encoder 13, and the like. The carriage moving mechanism 11 includes a carriage to which the recording head 8, which is one type of liquid discharging head, is attached; and a drive motor (for example, a DC motor) that drives this carriage through a timing belt or the like (not shown). The recording head 8 mounted on the carriage is moved in a main scanning direction. The paper feeding mechanism 12 includes a paper feeding motor, a paper feeding roller and the like, and sequentially feeds recording paper sheets (one type of discharge target) onto a platen and performs vertical scanning. Furthermore, the linear encoder 13 outputs an encoder pulse regarding a scanning position of the recording head 8 mounted on the carriage to the control section 6 via the internal I/F 10 as information on the scanning position in the main scanning direction. The control section 6 can grasp the scanning position (current position) of the recording head 8 on the basis of the encoder pulse received from the linear encoder 13.

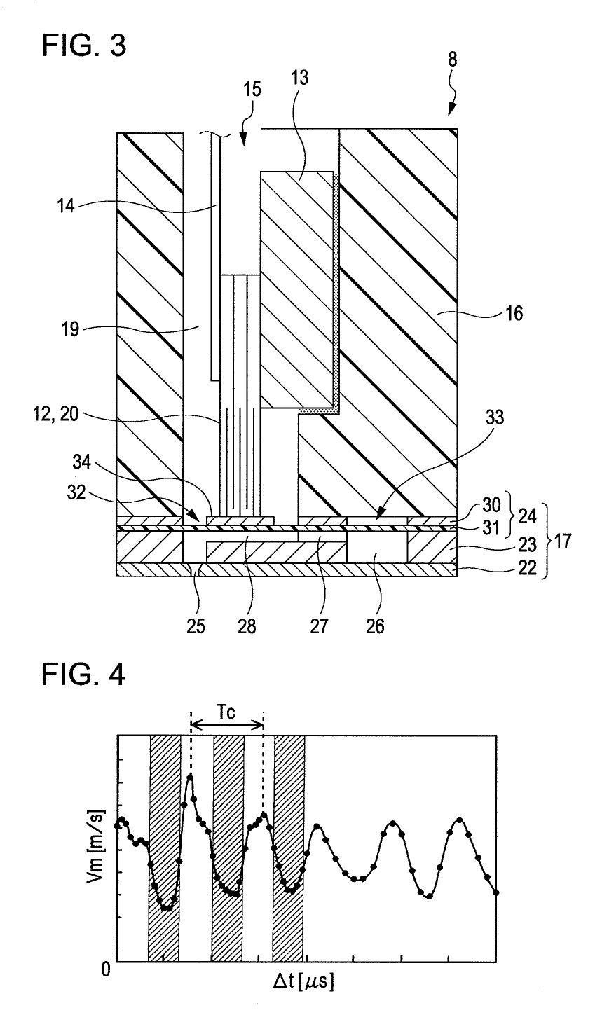

FIG. 3 is a sectional view of essential parts of the above-described recording head 8. In the present embodiment, the recording head 8 includes a vibrator unit 15 that integrates a piezoelectric vibrator group 12, a fixed plate 13, a flexible cable 14 and the like into one unit; a head case 16 capable of containing this vibrator unit 15; and flow path units 17 that form a series of ink flow paths (liquid flow paths) that extend from a common ink chamber (common liquid chamber) to nozzle openings through pressure generating chambers.

First, the vibrator unit 15 will be described. Piezoelectric vibrators 20 (one type of pressure generator in the embodiment of the invention) constituting the piezoelectric vibrator group 12 are formed to have a long narrow comb tooth shape in the longitudinal direction thereof, and are cut to have an extremely small width on the order of several dozen μm. Furthermore, the piezoelectric vibrators 20 are formed as longitudinally vibrating piezoelectric vibrators that are capable of extending and contracting in the longitudinal direction. Each piezoelectric vibrator 20 is fixed in a so-called cantilever state by a fixed end thereof being joined onto the fixed plate 13 and a free end thereof protrudes further toward the outside than an edge of the fixed plate 13. Furthermore, as discussed below, the tip of the free end of each of the piezoelectric vibrators 20 is joined to an island portion 34 constituting a diaphragm section 32 for the respective flow path unit 17. The flexible cable 14 is electrically connected to the outer surface of the fixed end of the piezoelectric vibrator 20 on the opposite side to the fixed plate 13. In addition, the fixed plate 13 that supports each of the piezoelectric vibrators 20 is composed of a metal plate provided with rigidity capable of withstanding a reactive force of the piezoelectric vibrators 20.

Next, the flow path units 17 will be described. The flow path units 17 are formed of a nozzle plate 22, a flow path forming substrate 23, and a vibration plate 24. The nozzle plate 22 is arranged and stacked on one surface of the flow path forming substrate 23 and the vibration plate 24 is arranged and stacked on the other surface of the flow path forming substrate 23, on the side opposite to the nozzle plate 22, and they are integrated by using adhesion or the like.

The nozzle plate 22 is a thin stainless steel plate in which a plurality of nozzle openings 25 are formed in a row at a pitch corresponding to a dot formation density. In the present embodiment, for example, 180 of the nozzle openings 25 are formed in a row. A nozzle row is constituted by these nozzle openings 25. Furthermore, two of these nozzle rows are provided side by side.

The flow path forming substrate 23 is a plate-shaped component that forms a series of ink flow paths (one type of liquid flow path) constituted by a reservoir 26, ink supply openings 27, and pressure generating chambers 28. Specifically, this flow path forming substrate 23 is a plate-shaped component that as well as forming a plurality of spaces that will become the pressure generating chambers 28, corresponding to the respective nozzle openings 25, in such a manner as to be divided by partitions, also forms spaces that will become the ink supply openings 27 and the reservoir 26. Furthermore, the flow path forming substrate 23 of the present embodiment is prepared by subjecting a silicon wafer to etching. The above-described pressure generating chambers 28 are formed as long narrow chambers that extend perpendicularly to the direction in which the nozzle openings 25 are provided in rows (nozzle row direction), and the ink supply openings 27 are formed as narrow constricting sections, in which the flow path width is small, that allow the pressure generating chambers 28 and the reservoir 26 to communicate with each other. In addition, the reservoir 26 is a chamber for supplying ink stored in an ink cartridge (not shown) to each of the pressure generating chambers 28 and communicates with each of the pressure generating chambers 28 through the corresponding ink supply opening 27.

The vibration plate 24 is a composite plate having a two-layer structure in which a resin film 31, such as PPS (polyphenylene sulfide) or the like, is laminated on top of a support plate 30 made of a metal such as stainless steel or the like and is a component that in addition to sealing one open side of the pressure generating chambers 28 and having diaphragm sections 32 for changing the volume of the pressure generating chambers 28, also has a compliance section 33 formed therein that seals one open side of the reservoir 26. Furthermore, the diaphragm sections 32 are formed by performing etching on portions of the support plate 30 corresponding to the pressure generating chambers 28 to remove portions having a circular shape, and forming island portions 34 to be joined to the tips of the free ends of the piezoelectric vibrators 20. Similar to the planar shape of the pressure generating chambers 28, these island portions 34 have a long narrow block shape extending in a direction perpendicular to the direction in which the nozzle openings 25 are provided in rows and the resin film 31 surrounding the island portions 34 functions as an elastic film. In addition, for a portion to function as the compliance section 33, in other words a portion corresponding to the reservoir 26, the support plate 30 is etched following the open shape of the reservoir 26 so that a portion thereof is removed to leave only the resin film 31.

Next, the electrical configuration of the recording head 8 will be described. As shown in FIG. 1, the recording head 8 is provided with a shift register circuit constituted by a first shift register 41 and a second shift register 42, a latch circuit constituted by a first latch circuit 43 and a second latch circuit 44, a decoder 45, a control logic 46, a level shifter circuit constituted by a first level shifter 47 and a second level shifter 48, a switch circuit constituted by a first switch 49 and a second switch 50, and the piezoelectric vibrator 20. Furthermore, the shift registers 41 and 42, the latch circuits 43 and 44, the level shifters 47 and 48, the switches 49 and 50, and the piezoelectric vibrator 20 are each provided in just a number that corresponds to the number of individual nozzle openings 25.

The recording head 8 is made to discharge ink in accordance with recording data from the printer controller 1. In the present embodiment, upper bit groups of recording data and lower bit groups of recording data each composed of two bits are sequentially sent to the recording head 8, and therefore, first, the upper bit groups of recording data are set in the second shift registers 42. When the upper bit groups of recording data have been set in the second shift registers 42 for all of the nozzle openings 25, these upper bit groups are shifted to the first shift registers 41. Simultaneously with this operation, the lower bit groups of recording data are set in the second shift registers 42.

The first latch circuit 43 is electrically connected to the first shift register 41 in a stage subsequent to first shift register 41 and the second latch circuit 44 is electrically connected the second shift register 42 in a stage subsequent to the second shift register 42. In addition, when a latch pulse is input to each of the latch circuits 43 and 44 from the printer controller 1 side, the first latch circuit 43 latches the upper bit group of recording data and the second latch circuit 44 latches the lower bit group of recording data. The recording data (upper bit data and lower bit data) latched by each of the latch circuits 43 and 44 is output to the decoder 45. The decoder 45 generates pulse selection data for selecting each pulse constituting the driving signals COM1 and COM2 on the basis of the upper bit group and lower bit group of recording data.

In the present embodiment, pulse selection data is generated for each of the driving signals COM1 and COM2. In other words, first pulse selection data corresponding to the first driving signal COM1 is composed of a total of two bits of data corresponding to the large dot discharge pulse DPL (period T11) and the middle dot discharge pulse DPM (period T12). Furthermore, second pulse selection data corresponding to the second driving signal COM2 is composed of a total of two bits of data corresponding to the small dot discharge pulse DPS (period T21) and the large dot discharge pulse DPL (period T22).

In addition, a timing signal from the control logic 46 is also input to the decoder 45. The control logic 46 generates the timing signal synchronously with input of the latch signal and the channel signal. The timing signal is also generated for each of the driving signals COM1 and COM2. The pulse selection data generated by the decoder 45 is sequentially input to each of the level shifters 47 and 48 from the upper bit side at a timing specified by the timing signal. The level shifters 47 and 48 function as voltage amplifiers and, when the pulse selection data is [1], output an electrical signal boosted to a voltage on the order of, for example, several dozen volts, a voltage with which the corresponding first and second switches 49 and 50 can be driven. That is, when first pulse selection data is [1], an electrical signal is output to the first switch 49, and when second pulse selection data is [1], an electrical signal is output to the second switch 50.

The first driving signal COM1 is supplied from the first driving signal generating section 9A to the input side of the first switch 49, and the second driving signal COM2 is supplied from the second signal generating section 9B to the input side of the second switch 50. In addition, the piezoelectric vibrator 20 is connected to the output side of each of the first and second switches 49 and 50. That is, the first switch 49 is configured to perform switching between supplying and not supplying the first driving signal COM1 to the piezoelectric vibrator 20 and the second switch 50 is configured to perform switching between supplying and not supplying the second driving signal COM2 to piezoelectric vibrator 20. Furthermore, the first switch 49 and the second switch 50 performing this kind of operation function as selection supply devices.

The above-described pulse selection data is used to control each of the first and second switches 49 and 50. That is, in a period in which the pulse selection data input to the first switch 49 is [1], the first switch 49 is in a conductive state and the first driving signal COM1 is supplied to the piezoelectric vibrator 20. Similarly, in a period in which the pulse selection data input to the second switch 50 is [1], the second switch 49 is in a conductive state and the second driving signal COM2 is supplied to the piezoelectric vibrator 20. On the other hand, in a period in which the pulse selection data input to each of the first and second switches 49 and 50 is [0], each of the first and second switches 49 and 50 is in a disconnected state and a driving signal is not supplied to the piezoelectric vibrator 20. In short, pulses of a period in which [1] is set as pulse selection data are selectively supplied to the piezoelectric vibrator 20.

As described above, individual pulses are selected and supplied to individual piezoelectric vibrators 20 corresponding to respective individual nozzle openings 25 in accordance with pulse selection data generated on the basis of recording data, in a certain period T, and consequently, the case in which the large dot discharge pulse DPL is supplied to the piezoelectric vibrator 20 that corresponds to a certain nozzle opening 25 and a small dot discharge pulse DPS is supplied to the piezoelectric vibrator 20 that corresponds to a nozzle opening 25 that is adjacent to the certain nozzle opening 25, can occur with certainty during printing using recording data.

Next, the discharge pulses included in each of the driving signals COM1 and COM2 generated by the driving signal generating circuit 9 will be described.

First, the middle dot discharge pulse DPM generated in the period T12 in the first driving signal COM1 will be described. As shown in FIG. 2, the middle dot discharge pulse DPM is composed of a first expansion element P11 (pressure generating chamber expansion element), a first expansion hold element P12 (expansion maintaining element), a first contraction element P13 (discharge element), a first damping hold element P14, and a first expansion damping element P15. The first expansion element P11 is a waveform element that increases the potential comparatively gradually from an intermediate potential VHB to a first expansion potential VH1 at a constant gradient of such a magnitude that discharging of ink is not caused. The first expansion hold element P12 is a waveform element that is fixed at the first expansion potential VH1. The first contraction component P13 is a waveform element that decreases the potential at a steep gradient from the first expansion potential VH1 to a first contraction potential VL1. The first damping hold element P14 is a waveform element that maintains the first contraction potential VL1 for a given period. In addition, the first expansion damping element P15 is a waveform element that returns the potential from the first contraction potential VL1 to the intermediate potential VHB at a constant gradient of such a magnitude that discharging of ink is not caused.

When the middle dot discharge pulse DPM having this structure is supplied to the piezoelectric vibrator 20, first, the piezoelectric vibrator 20 contracts in the longitudinal direction thereof due to the first expansion element P11 and the pressure generating chamber 28 expands from its normal volume corresponding to the intermediate potential VHB to an expanded volume corresponding to the first expansion potential VH1. With this expansion, along with the meniscus markedly drawing in toward the pressure generating chamber 28 side, ink is supplied from the reservoir 26 side into the pressure generating chamber 28 via the supply opening 27. In addition, the expanded state of the pressure generating chamber 28 is maintained throughout the supply period of the first expansion hold element P12. Subsequently, the piezoelectric vibrator 20 extends in response to supply of the first contraction element P13. The pressure generating chamber 28 is suddenly caused to contract to a contracted volume corresponding to the first contraction potential VL1 from the expanded volume by the extension of the piezoelectric vibrator 20. Ink inside the pressure generating chamber 28 is compressed by this sudden contraction of the pressure generating chamber 28, whereby ink is discharged in an amount corresponding to a middle dot from the nozzle opening 25. The contracted state of the pressure generating chamber 28 is maintained throughout the supply period of the first damping hold element P14, and during this time the pressure of the ink inside the pressure generating chamber 28 that had decreased due to the discharge of the ink again increases due to the natural oscillation of the ink. The first expansion damping element P15 is supplied at a timing that matches the timing of this increase in pressure. The pressure generating chamber 28 expands and returns to its normal volume due to supply of the first expansion damping element P15, and the change in pressure of the ink inside the pressure generating chamber 28 is absorbed.

Next, the small dot discharge pulse DPS generated in the period T21 in the above-described second driving signal COM2 will be described. The small dot discharge pulse DPS is composed of a second expansion element P21, a second expansion hold element P22, a second contraction element P23, a contraction hold element P24, a third expansion element P25, a third expansion hold element P26, a third contraction element P27, a second damping hold element P28 and a second expansion damping element P29. The second expansion element P21 is a waveform element that increases the potential from the intermediate potential VHB to a second expansion potential VH2 and the second expansion hold element P22 is a waveform element that is fixed at the second expansion potential VH2. Furthermore, the second contraction element P23 is a waveform element that suddenly decreases the potential from the second expansion potential VH2 to a first intermediate potential VM1, the contraction hold element P24 is a waveform element that is fixed at the first intermediate potential VM1, the third expansion element P25 is a waveform element that increases the potential from the first intermediate potential VM1 to a second intermediate potential VM2 and the third expansion hold element P26 is a waveform element that is fixed at the second intermediate potential VM2. In addition, the third contraction element P27 is a waveform element that decreases the potential at a steep gradient from the second intermediate potential VM2 to a second contraction potential VL2, the second damping hold element P28 is a waveform element that is fixed at the second contraction potential VL2 and the second expansion damping element P29 is a waveform element that returns the potential from the second contraction potential VL2 to the intermediate potential VHB at a constant gradient of such a magnitude that discharging of ink is not caused.

When the small dot discharge pulse DPS having this structure is supplied to the piezoelectric vibrator 20, first, the piezoelectric vibrator 20 rapidly contracts in the longitudinal direction thereof due to the second expansion element P21 and, together with this, the island portion 34 moves in a direction away from the pressure generating chamber 28. Due to the movement of the island portion 34, the pressure generating chamber 28 rapidly expands from its normal volume to an expanded volume corresponding to the second expansion potential VH2. A comparatively strong negative pressure is generated in the pressure generating chamber 28 by the expansion of the pressure generating chamber 28 and, together with the meniscus being drawn in toward the pressure generating chamber 28 side, ink is supplied from the reservoir 26 side into the pressure generating chamber 28. Furthermore, the expanded state of the pressure generating chamber 28 is maintained throughout the supply period of the second expansion hold element P22.

Subsequent to this, the piezoelectric vibrator 20 extends in response to supply of the second contraction element P23. The island portion 34 suddenly moves in a direction toward the pressure generating chamber 28 due to the extension of the piezoelectric vibrator 20. The pressure generating chamber 28 is made to suddenly contract by the movement of the island portion 34 from the expanded volume to a discharge volume corresponding to the first intermediate potential VM1. Furthermore, the pressure of ink within the pressure generating chamber 28 is increased by this sudden contraction of the pressure generating chamber 28 and a central portion of the meniscus is pushed outward toward the discharge side. Next, the contraction hold element P24 is supplied and the discharge volume is maintained for a short period. Subsequently, the volume of the pressure generating chamber 28 expands again a little due to the contraction of the piezoelectric vibrator 20 caused by the third expansion element P25. After the third expansion hold element P26, the piezoelectric vibrator 20 extends due to the third contraction element P27 and the volume of the pressure generating chamber 28 suddenly contracts again. In the supply period from the contraction hold element P24 to the third contraction element P27, the central portion of the meniscus breaks and this portion is discharged as ink of an amount corresponding to a small dot. After this, due to supplying of the second damping hold element P28 and the second expansion hold element P29, the pressure generating chamber 28 expands so as return to its normal volume and the change in pressure of the ink in the pressure generating chamber 28 is absorbed.

The large dot discharge pulse DPL generated in the period T11 of the first driving signal COM1 and the large dot discharge pulse DPL generated in the period T22 of the second driving signal COM2 both have the same waveform. Each of these large dot discharge pulses DPL is composed of a fourth expansion element P31 (pressure generating chamber expansion element), a fourth expansion hold element P32 (expansion maintaining element), a fourth contraction element P33 (discharge element), a third damping hold element P34 and a third expansion damping element P35. The fourth expansion element P31 is a waveform element that increases the potential comparatively gradually at a constant gradient from the intermediate potential VHB to a third expansion potential VH3. The fourth expansion hold element P32 is a waveform element that is fixed at the third expansion potential VH3. The fourth contraction element P33 is a waveform element that decreases the potential at a steep gradient from the third expansion potential VH3 to a third contraction potential VL3. The third damping hold element P34 is a waveform element that maintains the potential for a certain period at the third contraction potential VL3. Finally, the third expansion damping element P35 is a waveform element that returns the potential from the third contraction potential VL3 to the intermediate potential VHB.

When the large dot discharge pulse DPL having this structure is supplied to the piezoelectric vibrator 20, first, the piezoelectric vibrator 20 contracts in the longitudinal direction thereof due to the fourth expansion element P31, and the pressure generating chamber 28 expands from its normal volume corresponding to intermediate potential VHB to the expanded volume corresponding to the third expansion potential VH3. Due to this expansion, together with the meniscus being markedly drawn in toward the pressure generating chamber 28 side, ink is supplied through the ink supply opening 27 from the reservoir 26 side into the pressure generating chamber 28. Furthermore, this expanded state of the pressure generating chamber 28 is maintained throughout the generation period of the fourth expansion hold element P32. Subsequently, the piezoelectric vibrator 20 extends in response to supply of the fourth contraction element P33. Due to this extension of the piezoelectric vibrator 20, the pressure generating chamber 28 is made to suddenly contract from the expanded volume to the contracted volume corresponding to the third contraction potential VL3. As a result of this rapid contraction of the pressure generating chamber 28, the pressure of the ink inside the pressure generating chamber 28 is increased and ink is discharged from the nozzle opening 25 in an amount corresponding to a large dot. Next, the third damping hold element P34 and the expansion damping element P35 are supplied, and thereby the pressure generating chamber 28 expands and returns to its normal volume and the change in the pressure of the ink inside the pressure generating chamber 28 is absorbed.

In the present embodiment, the timing (beginning of pulse) tm1 at which the large dot discharge pulse DPL is generated in the first driving signal COM1 and the timing tm2 at which the small dot discharge pulse DPS is generated in the second driving signal COM2 are different. That is, as shown in FIG. 2, in the present embodiment, the small dot discharge pulse DPS in the second driving signal COM2 is generated so as to be delayed by just Δt from the large dot discharge pulse DPL in the first driving signal COM1. Similarly, the timing tm3 at which the middle dot discharge pulse DPM is generated in the first driving signal COM1 and the timing tm4 at which the large dot discharge pulse DPL is generated in the second driving signal COM2 are different.

Here, the above-described recording head 8 has been designed to be of reduced size from the viewpoints of weight reduction and space reduction. Along with this, the nozzle openings 25 have been formed with a higher density and the thickness of partitions separating adjacent pressure generating chambers 28 from one another has been reduced. Consequently, it has become easy for pressure oscillations generated in the ink inside a pressure generating chamber 28 by driving of the piezoelectric vibrator 20 to be transmitted to an adjacent pressure generating chamber 28 via the partition. Therefore, sometimes, depending on the phase of the vibration of the meniscus, the meniscus of the adjacent nozzle opening 25 is also vibrated and as a result discharge of ink from the adjacent nozzle opening 25 becomes unstable. Specifically, when an operation of discharging ink from the nozzle opening 25 is started in a state in which the meniscus bulges toward the side opposite the pressure generating chamber side, that is, the discharge side, an air bubble is drawn completely in together with drawing in of the meniscus due to the pressure generating chamber expansion element. In other words, in the state in which the meniscus bulges toward the discharge side, at the time of drawing in of the meniscus, it is thought that, because there is a large difference in speed between drawing in of the central portion of the meniscus and drawing in of the peripheral portion of the meniscus in the vicinity of the periphery of the nozzle opening 25, an air bubble is sucked in between the central portion of the meniscus and the peripheral portion of the meniscus. In addition, due to this air bubble, there is a concern that discharge of ink becomes unstable in that, for example, the flight direction of satellite ink is curved. In particular, as in the present embodiment, in the case in which ink is discharged in differing amounts from adjacent nozzle openings 25 in the same recording period, interference (so-called “crosstalk) between these nozzle openings 25 is more noticeable and, specifically, there is a tendency for discharge from the nozzle from which a smaller amount of ink is being discharged to become unstable.

Therefore, in the printer controller 1 according to the embodiment of the invention, by optimizing the difference (time Δt) on the time axis between the beginning tm1 of the large dot discharge pulse DPL in the first driving signal COM1 and the beginning tm2 of the small dot discharge pulse DPS in the second driving signal COM2, and using the large dot discharge pulse DPL for one of adjacent nozzle openings 25 and the small dot discharge pulse DPS for the other one of the adjacent nozzle openings 25, even in the case in which ink is discharged from each of the nozzle openings 25 within the same recording period, discharge from the other nozzle opening 25 is prevented from becoming unstable. Hereafter, this point will be explained.

FIG. 4 shows a graph for a case in which by using the large dot discharge pulse DPL for one nozzle opening 25A and the small dot discharge pulse DPS for another nozzle opening 25B, the nozzle openings 25A and 25B being a pair of adjacent nozzle openings 25, ink is discharged from each of the nozzle openings 25A and 25B within the same recording period. The graph shows the change in flight speed Vm (m/s) of ink from the other nozzle opening 25B when the above-described time Δt (μs) is changed. When the time Δt has a value of 0, the large dot discharge pulse DPL and the small dot discharge pulse DPS are generated simultaneously and ink is discharged simultaneously from both of the nozzle openings 25A and 25B.

Periodic changes in the flight speed Vm of the ink with the time Δt can be understood from FIG. 4. That is, when the piezoelectric vibrator 20 corresponding to the nozzle opening 25A is driven using the large dot discharge pulse DPL, a natural oscillation of the pressure inside the pressure generating chamber 28 is stimulated and as a result the meniscus of the other nozzle opening 25B is also vibrated by this pressure oscillation, and the flight speed Vm of ink fluctuates in accordance with the phase of this oscillation. More specifically, when ink is discharged from the nozzle opening 25B at a timing at which the pressure oscillation is moving in a direction opposite to the discharge direction (toward the pressure generating chamber 28), the flight speed of the ink decreases, and conversely when ink is discharged from the nozzle opening 25B at a timing at which the pressure oscillation is moving in the discharge direction, the flight speed of the ink increases. The period of change of the flight speed Vm approximately matches the period of change of the pressure oscillation generated in the ink inside the pressure generating chamber 28, that is, the Helmholtz natural oscillation period Tc.

Furthermore, as described above, when an operation of discharging ink is started in a state in which the meniscus bulges out toward the discharge side and the meniscus is drawn in toward the pressure generating chamber 28 side, together with this, an air bubble is drawn completely in. This phenomenon is understood as occurring in the case in which an operation of discharging ink is started simultaneously for both the nozzle opening 25A and the nozzle opening 25B. Consequently, in the present embodiment, it is ensured that an operation of discharging ink from the nozzle opening 25B by using the small dot discharge pulse DPS is started in a state in which the meniscus in the nozzle opening 25B has been drawn in toward the pressure generating chamber 28 side to a certain extent (areas indicated by hatching in FIG. 4). Specifically, the above-described time Δt is determined by using Eq. (a) below. Here, Tc is the Helmholtz natural oscillation period within the pressure generating chamber 28 and n is a natural number.

(n−½)Tc<Δt<nTc (a)

From the viewpoint of shortening the recording period as much as possible, it is desirable that n=1.

Here, the time Δt is determined by using the above-described Eq. (a) and when an operation of discharging ink is started in the state in which the meniscus in the nozzle opening 25B has been drawn in, as shown in FIG. 4, the flight speed of ink is decreased and at this time curving of satellite ink or the like is suppressed and stability of discharge is ensured so that decreasing of the flight speed of ink is not a problem.

Similarly, in the case in which the middle dot discharge pulse DPM in the first driving signal COM1 is made to be a first discharge pulse and the large dot discharge pulse DPL in the second driving signal COM2 is made to be a second discharge pulse, the difference (time Δt′) on the time axis between the beginning tm3 of the middle dot discharge pulse DPM and the beginning tm4 of the large dot discharge pulse DPL is determined by using the above-described Eq. (a).

In this way, by setting the time Δt (Δt′) from the beginning of the first discharge pulse of the first driving signal COM1 to the beginning of the second discharge pulse of the second driving signal COM2, in the case in which the first discharge pulse and the second discharge pulse are respectively used to discharge ink from one nozzle opening 25A and another nozzle opening 25B from among adjacent nozzle openings 25 within the same recording period, the operation of discharging ink from the nozzle opening 25B is started in a state in which the meniscus has been drawn in toward the pressure generating chamber 28 side and thereby sucking in of an air bubble can be suppressed. Thereby, curving of the flight of ink caused by an air bubble, and the like, can be prevented and discharging of ink from the nozzle opening 25B can be stabilized. As a result, ink can be discharged and made to hit recording paper, which is a discharge target, with good accuracy.

In addition, the smaller the amount of liquid to be discharged by a discharge pulse, the more easily the discharge is affected by pressure oscillations due to discharges from adjacent nozzle openings 25. On the other hand, the larger the amount of liquid to be discharged by a discharge pulse, the more easily the pressure oscillation due to the discharge affects discharges from adjacent nozzle openings 25. Therefore, not limited to the present embodiment, as in the present embodiment, embodiments of the invention are applicable to the case in which a larger amount of ink is discharged using a first discharge pulse than with a second discharge pulse. Furthermore, embodiments of the invention are also applicable to the case in which the large dot discharge pulse DPL that causes a maximum amount of ink to be discharged, is made to be the first discharge pulse. Still furthermore, embodiments of the invention are also applicable to the case in which the small dot discharge pulse DPS that causes a minimum amount of ink to be discharged, is made to be the second discharge pulse.

The invention is not limited to the above-described embodiment and various modifications can be made on the basis of the description of scope of the claims.

The waveform structures of the driving signals COM1 and COM2 are not limited to those examples illustrated in the above-described embodiment and the invention can be applied to driving signals with a variety of structures.

For example, in the above-described embodiment, a waveform structure in which a first discharge pulse and a second discharge cause different amounts of ink to be discharged, was illustrated as an example. However, the invention is not limited to this and, for example, the invention can also be applied to a waveform structure in which a first discharge pulse and a second discharge pulse cause the same amount of ink to be discharged. In such a waveform structure, when Δt is made to be 0 and discharging of ink is simultaneously performed from adjacent nozzle openings 25, crosstalk therebetween is small. However, when ink is simultaneously discharged from a multiplicity of nozzle openings 25 using this waveform structure, sometimes crosstalk is generated between adjacent nozzle openings 25. Therefore, also for this waveform structure, by determining the time Δt between the first discharge pulse and the second discharge pulse by using the above-described Eq. (a), crosstalk can be suppressed.

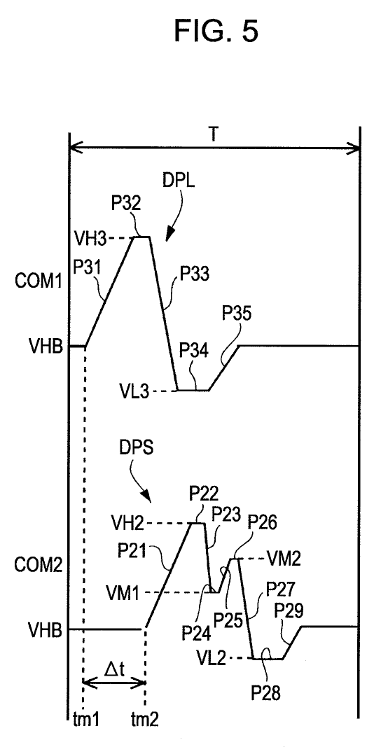

Furthermore, in the above-described embodiment, a waveform structure in which two discharge pulses are arranged in each of the first driving signal COM1 and the second driving signal COM2 was illustrated as an example. However, the invention is not limited to this, and, for example, as shown in FIG. 5, a waveform structure can also be adopted in which one discharge pulse is arranged in each of the first driving signal COM1 and the second driving signal COM2. In this example, the large dot discharge pulse DPL is included in the first driving signal COM1 as the first discharge pulse, the small dot discharge pulse DPS is included in the second driving signal COM2 as the second discharge pulse and the time Δt from the beginning of the large dot discharge pulse DPL to the beginning of the small dot discharge pulse DPS is determined by using the above-described Eq. (a). Of course, although one discharge pulse may be included, three or more discharge pulses may be included in each of the first driving signal COM1 and the second driving signal COM2, and differing numbers of discharge pulses may be included in the first driving signal COM1 and the second driving signal COM2.

Furthermore, as shown in FIG. 5, a waveform structure can also be adopted in which the beginning of the second discharge pulse is set to be in the middle (between the beginning and trailing edge, more specifically, between the beginning of the pressure generating chamber expansion element and the trailing edge of the discharge element) of the first discharge pulse. For this waveform structure as well, by determining the time Δt from the beginning of the first discharge pulse (large dot discharge pulse DPL) to the beginning of the second discharge pulse (small dot discharge pulse DPS) by using the above-described Eq. (a), when the first discharge pulse and the second discharge pulse are respectively used to discharge ink from one nozzle opening 25A and another nozzle opening 25B from among adjacent nozzle openings 25 within the same recording period, discharge from the other nozzle opening 25B can be prevented from becoming unstable. Similarly, a waveform structure in which the beginning of the second discharge pulse is set so as to be in the middle of the first discharge pulse can also be adopted in the embodiment shown in FIG. 2.

Embodiments of the invention can be applied not only to printers, but also to various other liquid discharging apparatuses such as plotters, facsimile machines, copiers, and the like, and to liquid discharging apparatuses other than ink jet recording apparatuses such as apparatuses for manufacturing displays, electrodes, chips and the like, as long as the liquid discharging apparatuses are capable of controlling discharge of a liquid by using a plurality of driving signals.

The entire disclosure of Japanese Patent Application No. 2008-226800, filed Sep. 4, 2008 is expressly incorporated by reference herein.

What is claimed is:

1. A liquid discharging apparatus comprising:
a liquid discharging head having a nozzle opening, a pressure generating chamber communicating with the nozzle opening and a pressure generator that generates a change in the pressure of a liquid inside the pressure generating chamber, the liquid discharging head being capable of discharging the liquid from the nozzle opening by operation of the pressure generator; and
a driving signal generator that is capable of repeatedly generating in constant periods a first driving signal and a second driving signal that each include a discharge pulse for discharging the liquid by driving the pressure generator;
wherein, when the Helmholtz natural oscillation period inside the pressure generating chamber is denoted by Tc and n is taken to be a natural number, a time Δt from a beginning of a first discharge pulse included in the first driving signal to a beginning of a second discharge pulse included in the second driving signal satisfies (n−½)Tc<Δt<nTc.

2. The liquid discharging apparatus according to claim 1, wherein in a state in which a meniscus exposed through the nozzle opening has been drawn inward in a direction toward the pressure generating chamber by vibration of the Helmholtz natural oscillation period generated by driving of the pressure generator using the first discharge pulse, the time Δt is set so that a discharge operation is started by using the second discharge pulse.

3. The liquid discharging apparatus according to claim 1, wherein the first discharge pulse and the second discharge pulse cause different amounts of liquid to be discharged.

4. The liquid discharging apparatus according to claim 3, wherein the second discharge pulse causes a minimum amount of liquid to be discharged.

5. The liquid discharging apparatus according to claim 3, wherein the first discharge pulse causes a larger amount of liquid to be discharged than the second discharge pulse.

6. A method of controlling a liquid discharging apparatus that includes a liquid discharging head having a nozzle opening, a pressure generating chamber communicating with the nozzle opening and a pressure generator that generates a change in the pressure of a liquid in the pressure generating chamber, the liquid discharging head being capable of discharging the liquid from the nozzle opening by operation of the pressure generator; and a driving signal generator that is capable of repeatedly generating in constant periods a first driving signal and a second driving signal that each include a discharge pulse for discharging the liquid by driving the pressure generator, the method comprising:
when the Helmholtz natural oscillation period inside the pressure generating chamber is denoted by Tc and n is taken to be a natural number, determining a time Δt from a beginning of a first discharge pulse included in the first driving signal to a beginning of a second discharge pulse included in the second driving signal so that (n−½)Tc<Δt<nTc.
